(19) United States
(12) Patent Application Publication
(10) Pub. No.: US 2008/0273213 A1
(43) Pub. Date: Nov. 6, 2008

(54) System and method for enhancing and printing images

(76) Inventors: Chanan M. Steinhart, Palo Alto, CA (US); Yishai Steinhart, Palo Alto, CA (US)

Correspondence Address: NORMAN FRIEDLAND, 2855 PGA BOULEVARD, SUITE 200, PALM BEACH GARDENS, FL, 33410, US

(21) Appl. No.: 11/655,803

(22) Filed: Jan. 19, 2007

(51) Int. Cl. G06K 15/10

(52) U.S. Cl. 358/1.9

(57) ABSTRACT

A system and method are provided for integrating a workflow through an image enhancement process with a workflow through a printing process. Input files, which are preferably PDF files, arrive at the workflow, in which images are extracted from the input files to be sent through the image enhancement process, which may be performed within a separate computer system executing instructions of an image enhancement or management program, providing an output that is integrated back into the workflow, producing printable output files, which are preferably additionally PDF files.

### BACKGROUND OF THE INVENTION

1. Field of the Invention

The invention relates to a system and method for integrating an image level photo lab workflow including an image enhancement process with a document level workflow to a printing system, and, more particularly, to such a system and method applied to a document level workflow comprising files in a PDF file format.

2. Summary of the Background Information

Traditional photo lab workflow does include in many cases manipulation or enhancement on the image level during the process. Pro Labs (Labs that target professional photographers) quite often will manually enhance or color correct each image before they print. Such a correction can be done also via color correction software and can include other image enhancement procedures. This process is used to correct photographer's or camera's mistakes or to achieve consistent colors across images displayed on the same page.

Many labs will use Kodak's DP2 system to manage their workflow and drive their photo printers. DP2 is a Digital Print Production system that does manages customer, order, image, scanning, layout, job and production data. Using such a system, a lab will work, print, and adjust individual images during the printing process. Other systems or image enhancement software is available on the market.

ADOBE® PDF (Portable Document Format) has emerged in past years as a method preferred by the printing industry to transfer pages between systems used to create the pages and output devices, with PDF files acting as “Digital Film.” A PDF file encapsulates all needed information within the file, including images, fonts, color spaces, PostScript® and display information, page size, etc. A PDF file created correctly on one machine should, in a well managed process, display correctly and the same way on any screen, and print correctly and the same way on any printer.

The patent literature includes descriptions of systems providing image enhancement and printing capabilities. For example, U.S. Pat. No. 6,914,694 describes such a system including a server computer that stores data representing a plurality of images in a photo database. A server web interface enables communication over the Internet, and the server computer includes an image print application that enables images to be printed using a client computer connected to the server web interface over the Internet. The server computer also includes an image enhancement module that enhances an image for printing. In response to a print request, over the Internet, from the client computer, the server computer sends image data and the image enhancement module, to the client computer. The server computer activates the image print application to create print commands for a printer driver, and to create enhanced in the client computer with the image enhancement module prior to printing. The enhanced image data is removed from the client computer immediately following printing.

U.S. Pat. No. 6,967,742 describes a method for stabilizing the image quality of prints made on a printer when printing jobs are received from a number of different client computers. A first calibration control unit obtains correction data from a printer to be stored in a first memory. The first calibration control unit additionally receives normal print information from a client computer and corrects print data by referring to a correction table produced in accordance with the correction data when generating the print data based on the received print information.

The patent literature also describes methods for extracting data from PDF files and from other files. For example, U.S. Pat. No. 6,801,673 describes a method for extracting a section of a page of a PDF file, with the method including receiving an indication of a user-defined region on a PDF file page, designing an extraction region including all elements determined to be within the user-defined region, and placing the extraction region into a new file. The method may also include determining if one or more elements on the PDF page are within the user-defined region by applying inclusion rules based on whether an element's bounding box is within or intersects the user-defined region. The method may also include verifying the accuracy of the extraction by converting the user-defined region in the original PDF document and the extracted region by bitmap images and comparing the bitmap images bit by bit.

U.S. Pat. No. 6,044,375 describes a method for automatically extracting metadata from a document, with the method providing a computer readable document that includes blocks composed of words and an authority list that includes common uses of a set of words The method uses a neural network trained to extract metadata from groupings of data called compounds, which are created with one compound describing each of the blocks. Each compound includes the words making up the block, descriptive information about the block, and authority information associated with some of the words. The descriptive information may include such information as bounding box information, describing the size and position of the block, and font information, describing the size and type of font used by the words of the block. The authority information is located by comparing each of the words from the block to the authority list. The compounds are processed through the neural network to generate guesses including the likelihood that each of the guesses is correct. The method may additionally include providing a document knowledge base of positioning information and size information for metadata in known documents. If the document knowledge base is provided, the method includes deriving analysis data from the metadata guess and comparing the analysis data to the document knowledge base to determine metadata output.

### SUMMARY OF THE INVENTION

The present invention provides approaches forming a bridge connecting a document level workflow to a printing system with an image level workflow through image enhancement software. Preferably, the document level workflow is performed with files having the PDF file format, with images being extracted from the document level workflow for manipulation by the image enhancement software without harming data within the document level workflow, and with the enhanced images then being reassembled into the document level workflow before PDF files from the document level workflow are sent to a digital printer. The invention may be used, for example, in a pro lab environment or in a digital print shop environment.

According to one aspect of the invention, a method is provided for enhancing and printing at least one image, with the method including steps of:

receiving a computer readable input file including data describing the at least one image within a bridge computer system;

extracting image data describing the at least one image from the computer readable input file within the bridge computer system;

generating and storing a replacement package data structure including information identifying and locating the at least one image within the bridge server computer system;

manipulating the image data to enhance the at least one image and storing a corrected version of the image data within the bridge server computer system;

generating a printable output file by placing at least one image generated from the corrected version of the image data as determined according to the replacement data structure within the bridge server computer system; and

transmitting the printable output file to a printer for printing.

The image data may be manipulated within an image enhancement computer system executing instructions from an image enhancement routine, or the processor within the bridge server computer system may be operating in a multitasking environment, with image data being manipulated for image enhancement within the bridge server computer system.

The method may additionally include, after the computer readable input file is received and before the image data is extracted, a step of determining that the at least one image has not been eliminated by non-image data within the input file, and a step of determining that the at least one image is described in the input file by data in a supported format.

Preferably, both the computer readable input file and the printable output file are each in a PDF file format.

### BRIEF DESCRIPTION OF THE DRAWINGS

FIG. 1 is flow chart of an image enhancement and printing system built in accordance with the invention, showing a flow of data therein;

FIG. 2 is a block diagram of the image enhancement and printing system of FIG. 1;

FIG. 3 is flow chart of process steps occurring in a bridge server computer system within the image enhancement and printing system of FIG. 1 during execution of a bridge server routine therein, with FIG. 3 including an upper portion, indicated as FIG. 3A, and a lower portion, indicated as FIG. 3B;

FIG. 4 is a flow chart of process steps occurring in a determination of whether image enhancement is needed within the process steps of FIG. 3; and

FIG. 5 is a block diagram of an image enhancement and printing system built in accordance with an alternative version of the invention.

### DETAILED DESCRIPTION OF THE INVENTION

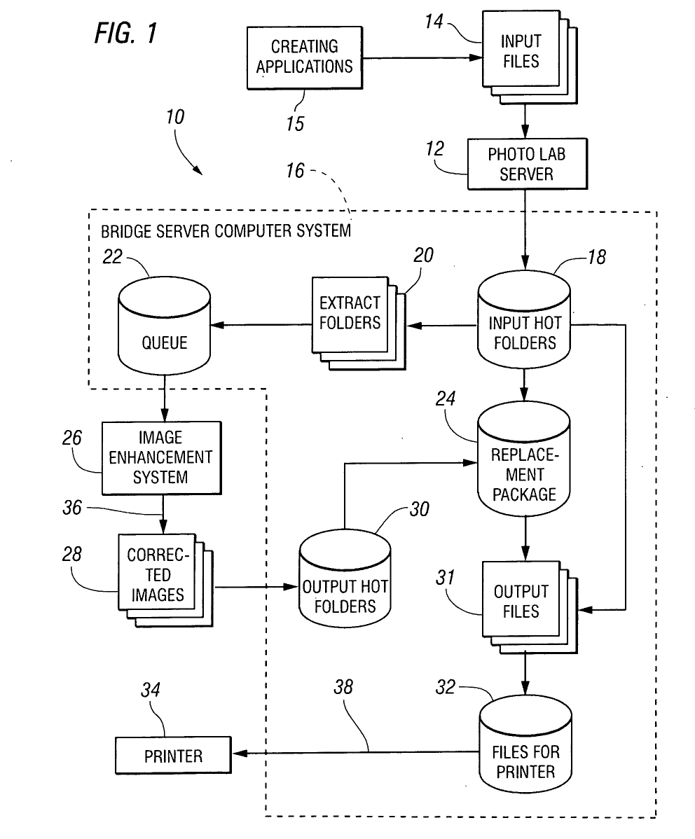

FIG. 1 is a flow chart of an image enhancement and printing system 10, built in accordance with the invention, showing a flow of data therein. The system 10 includes a photo lab server 12, receiving computer readable input files 14, including images to be printed. The Input files 14 have been generated by one or more creating applications 15, being transmitted to the photo lab server 12 over the Internet or being loaded into the photo lab server 12 from a computer readable medium, such as a compact disk. Preferably, the input files 14 are in the PDF format. The photo lab server 12 then transmits the input files 14 to a bridge server computer system 16, in which the Input files 14 are first stored within an input hot folder database 18.

Then, data describing images in files within the database stored within the files in the database 18 is extracted, forming a number of extraction folders 20, which are stored within a queue database 22, and additionally forming a number of replacement package files, which are stored within a replacement package database 24 including data describing the placement of extracted images. For example, each replacement package file may be a file in the PDF format including a copy of the data that has been extracted to form one or more images, with the same sequentially assigned numbers being associated with the extracted data for each image and with the corresponding image data stored within the queue database 22.

Non-image data may additionally be extracted from the files stored within the input hot folders database 16 for use in determining how image data should be processed. For example, such non-image data may be used to describe the placement of images on particular pages, or the non-image data may include tags placed by the creating applications 15 within the input files 14 to indicate that certain images should be ignored or discarded.

The system 10 additionally includes an image enhancement system 26, in which program instructions are executed for enhancing images. The image enhancement process may include color correction and image sharpening subroutines that are well known to those skilled in the art of image processing. For example, the image enhancement system 22 is a computer system executing a Kodak® DP2 software system for image enhancement. Image information is transmitted to the image enhancement system 26 from the queue database 22.

Corrected image data 28 from the image enhancement system 24 is transmitted back to the bridge server computer system 16, to be stored within an output hot folders database 30. Corrected images stored within the output hot folders database 30 are placed at locations indicated within the replacement package data structure 24, forming output files 31 that are ready for printing. Preferably, the output files 31 are files in the PDF format, which are stored in a files for printing database 32, to then be printed on a printer 34. The output files 31 may also include files transferred from the input hot folders database 18 without the extraction of images, if it has been determined that images should not be extracted from certain files that include data to be printed. Thus, the bridge server computer system 16 provides a bridge between an image level workflow 36 through the image enhancement system 24 and a document level workflow 38 between the photo lab server 12 and the printer 34.

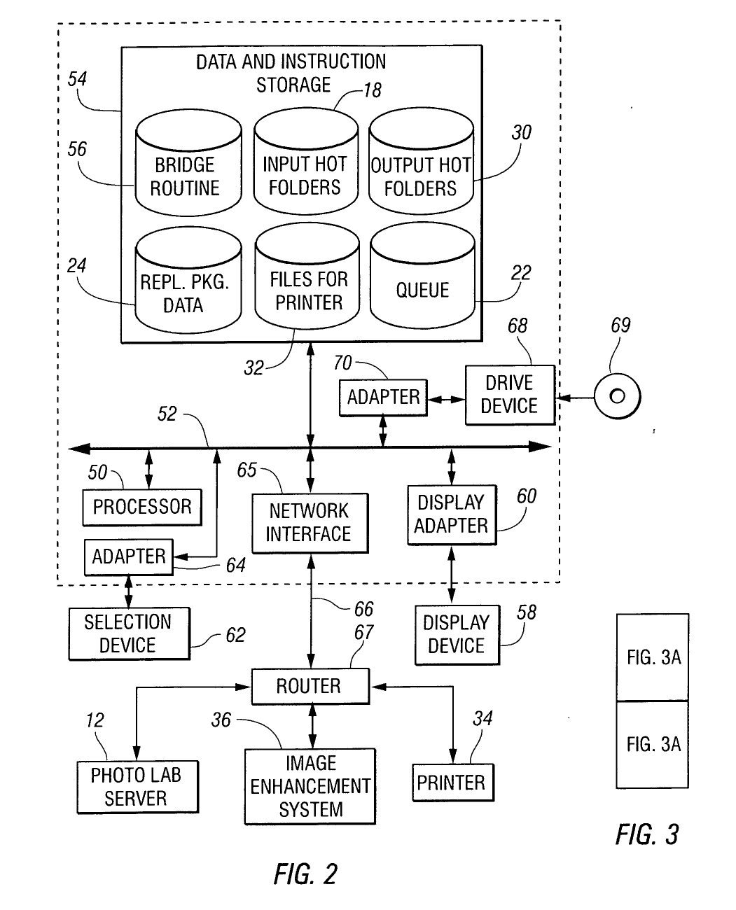

FIG. 2 is a block diagram of the image enhancement and printing system 10. The bridge server computer system 16 is a computer system including a processor 50, a data bus structure 52 and data and instruction storage 54, which includes the input hot folders database 18, the output hot folders 34, the queue database 22, the files for printer database 32, and the replacement package data structure 24, all of which have been described above in reference to FIG. 1. For example the data bus structure 52 includes a system bus and a PCI (Peripheral Component Interconnect) bus. The data and instruction storage 54 also stores a bridge server routine 56, including instructions executed within the processor 50 to provide for operation in accordance with the invention. A display device 58, connected to the bus structure 52 through an display adapter circuit 60, is used, for example, to display images of documents so that an individual using the bridge server computer system 16 can determine whether image enhancement is needed, with data describing a decision to provide image enhancement of an individual image being entered through a selection device 62 connected to the bus structure 52 through an adapter circuit 64.

The bridge server computer system 16 additionally includes a network interface circuit 65, connected to a LAN 66 (local area network). The photo lab server 12, image enhancement system 26, and printer 34 are also connected to the LAN 66 through a router 67. For example, the photo lab server 12 and the image enhancement system 26 are each computer systems, with the image enhancement system 26 running a software system such as Kodak's DP2 Digital Print Production system for enhancing individual images, including color correction.

Preferably, the bridge server computer system 16 additionally includes a drive device 68 for reading a computer readable medium 69, such as an optical disk. The drive device 68 is then connected to the-bus structure 52 through an adapter circuit 70. Data and program instructions, including the program instructions within the bridge routine 56 can be loaded into data and instruction storage 30 from the computer readable medium 36, which contains computer readable code,. Alternately, data and program instructions may be loaded into data and instruction storage through the network interface circuit 65 after being received over the LAN 66 in the form of a computer data signal embodied in a carrier wave.

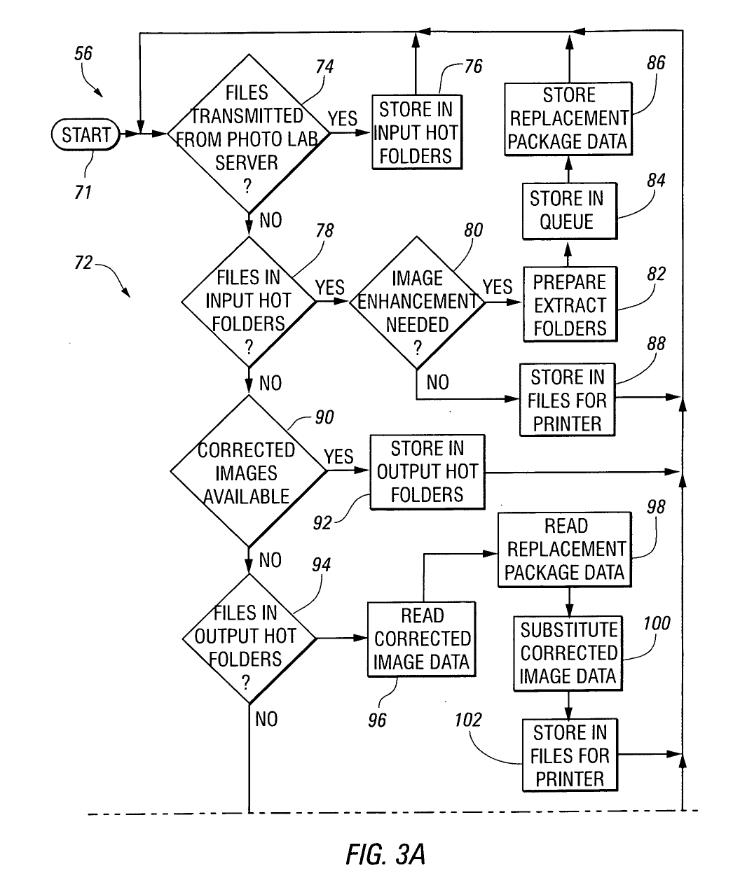

FIG. 3 is a flow chart of process steps occurring in the bridge server computer system 16 during execution of the bridge server routine 56. FIG. 3 includes an upper portion, indicated as FIG. 3A, and a lower portion, indicated as FIG.3B.

After starting in step 71, the bridge server routine 56 enters a loop 72, in which a number of determinations are made concerning events causing the execution of process steps. For example, if a determination is made in step 74 that input files 14 are being transmitted from the photo lab server 12, the input files 14 are stored within the input hot folders database 18 in step 76. Then, the routine 56 returns to the loop 72. If it is determined in step 78 that one or more files are available in the input hot folders database 18, a further determination is made in step 80 of whether image enhancement is needed within the available files. If it is needed, one or more extract folders 20 is formed in step 82, to be stored within the queue database 22 in step 84, with replacement package data being stored within the replacement package database 24 in step 86 before returning to the loop 72. On the other hand, if it is determined in step 80 that image enhancement is not needed within the available folders, the available files are stored as output files 31 in the files for printer database 32 in step 88.

If it is determined in step 90 that data for corrected images 28 is being transmitted from the image enhancement system 26, such data is stored in the output hot folders database 30 in step 92 before returning to the loop 72. If it is determined in step 94 that files are available within the output hot folders database 30, the corrected image data 28 Is read from the output hot folders database 30 in step 96, with the replacement package data being read from the replacement package data structure 24 in step 98, and with corrected output files 31 being generated in step 100 by placing the corrected images in the replacement package data. Then, in step 102, the corrected output files 31 are stored in the files for printer database 32. If it is determined in step 104 that files are available within the files for printer database 32, a further determination is made in step 106 of whether the printer 34 is available. If it is, one or more output files 31 are sent to the printer 34 in step 108 before returning to the loop 72.

The program may be ended, for example, by a user decision to shut down the bridge server computer system 16. If it is determined in step 110 that the program is to be shut down, the bridge server routine 56 ends in step 112. Otherwise, the bridge server routine 56 continues in loop 72.

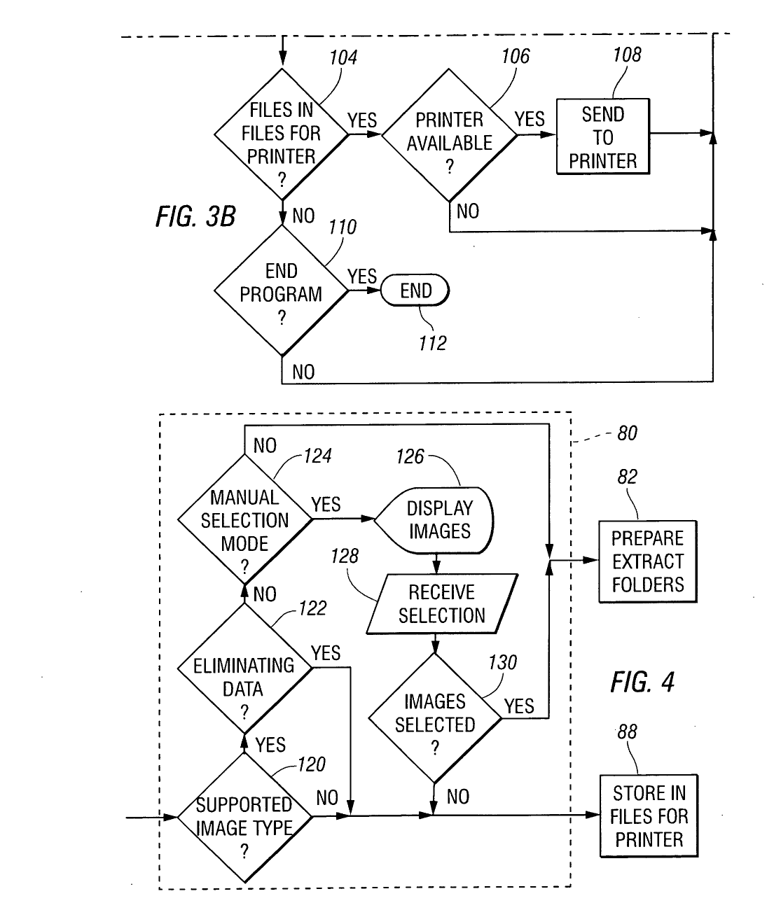

FIG. 4 is a flow chart of process steps occurring during an exemplary version of the determination, in step 80 of FIG. 3, of whether image enhancement is needed. After it is determined in step 78 that one or more input files 14 are present within the input hot folders database 16, the processes of step 80 begin in step 120 with a further determination of whether an input file 14 includes an image is a supported type. For example, all images within an input file 14 may include only images representing thumbnails, that do not require image enhancement, or images described by data written in a format that is not supported by the image enhancement process occurring within the image enhancement system 26. If it is determined in step 120, that there are no images that are of a supported type within the input file 14, the file 14 is transferred as an output file 31 to storage within the files for printer database 32 in step 88.

On the other hand, if it is determined in step 120 that one or more of the images within an input file 14 is of a supported type, a further determination is made in step 122 of whether all images have been eliminated by non-image data stored in the input file 14. For example, the input file 14 may be a PDF file including non-image data in the form of tags indicating that the images are to be ignored or not enhanced. Thus, if it is determined in step 122 that there are no images that are not eliminated by non-image data, the input file 14 is transferred as an output file 31 to storage within the files for printer database in step 88.

If it is determined in step 122 that one or more of the images within an input file 14 is not eliminated by non-image data in the input file 14, a further determination is made in step 124 of whether the bridge server computer system 16 is operating in a manual selection mode, in which the user operating the system 16 is provided with a means to select individual images for enhancement. If it is not operating in the manual selection mode, extract folders are prepared in step 82 to include the images not eliminated by the determinations of steps 120. 122. If the system 16 is operating in the manual selection mode, the images are displayed on the display device 58 in step 126. Then, the user selects the images to be enhanced using the selection device 62. For example, the selection device 62 may include a keyboard and a pointing device, such as a mouse, with the images being selected by typing identifying numbers on the keyboard or by using the pointing device to select individual images displayed on the display device 60. After the user selection is received in step 128, a determination is made in step 130 of whether one or more images have been selected. If no images have been selected, the input file 14 is transferred as an output file 31 to storage within the files for printer database in step 88. If one or more images have been selected, extract folders are prepared for the selected images in step 82.

Preferably, the input file 14 is a PDF file, which may include multiple pages. The processes described above in reference to FIG. 4 may be applied to multiple pages, to a single page, or to a fraction of a page, depending on the size and complexity of the pages within the input file 14.

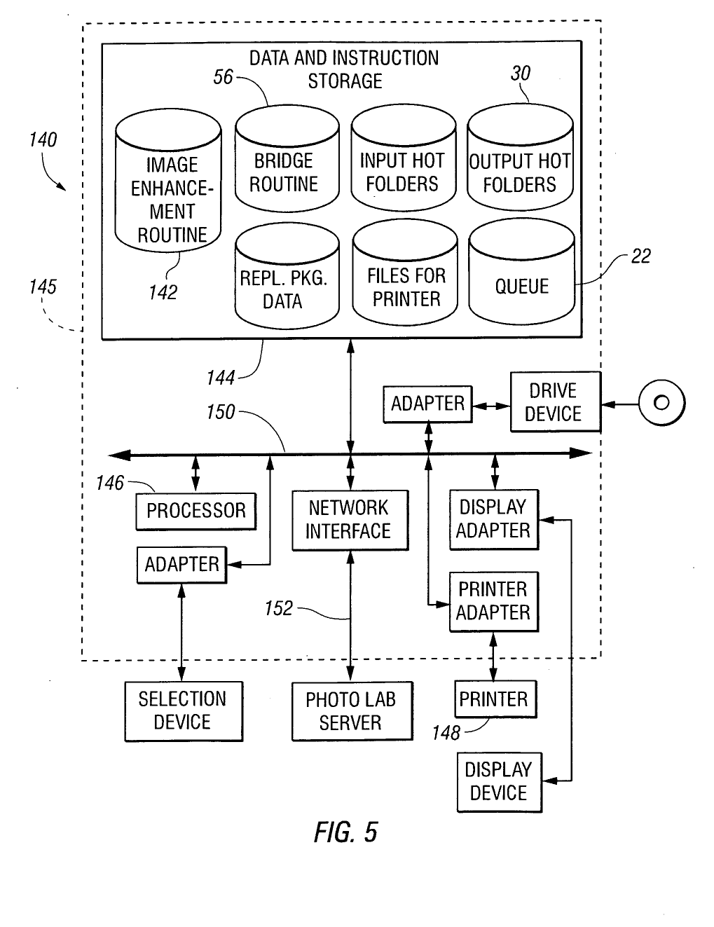

FIG. 5 is a block diagram of an image enhancement and printing system 140 built in accordance with an alternative version of the invention to include an image enhancement routine 142, for which data and instructions are stored within data and instruction storage 144 of a bridge server computer system 145. An image enhancement process of this routine 144 is used in place of image enhancement within the image enhancement system 26 of FIG. 1. The processor 146 operates in a multitasking environment to execute instructions within the image enhancement routine 142 and to additionally execute instructions in the bridge routine 56, which operates generally as described above in reference to FIG. 3, being therefore accorded a like reference number. Data stored within the queue database 22 is provided for use within the image enhancement routine 152, and data from the image enhancement routine 152 is stored within the output hot folders database 30. The image enhancement routine 142 performs various processes well known to those skilled in the art of image enhancement, such as color correction and image sharpening.

In the example of FIG. 5, a printer 148 is attached to the bus structure 150 of the bridge server computer system 145, instead of being connected through the LAN 152, in the manner described above in reference to FIG. 2. It is understood that either type of printer attachment may be used with a bridge server computer system otherwise built as described in reference to FIG. 2 or to FIG. 5. Other elements shown in FIG. 5 operate generally as described above in reference to FIG. 2.

While the invention has been shown and described in its preferred versions with some degree of particularity, it is understood that this description has been given only by way of example, and that many changes can be made without departing from the spirit and scope of the invention, as defined within the appended claims.

What is claimed is:

1. A method for enhancing and printing at least one image, wherein the method comprises:
receiving a computer readable input file including data describing the at least one image within a bridge server computer system;
extracting image data describing the at least one image from the computer readable input file within the bridge server computer system;
generating and storing a replacement package data structure including information identifying and locating the at least one image within the bridge server computer system;
manipulating the image data to enhance the at least one image and storing a corrected version of the image data within the bridge server computer system;
generating a printable output file by placing at least one image generated from the corrected version of the image data as determined according to the replacement data structure within the bridge server computer system; and
transmitting the printable output file to a printer for printing.

2. The method of claim 1, wherein the image data is manipulated to enhance the at least one image within an image enhancement computer system executing instructions from an image enhancement routine.

3. The method of claim 1, wherein
the bridge server includes a processor operating in a multitasking environment, and
the image data is manipulated to enhance the at least one image within the bridge server computer system.

4. The method of claim 1, wherein the computer readable input file and the printable output file are each in a PDF file format.

5. The method of claim 1, additionally comprising, after receiving the computer readable input file and before extracting the image data, steps of:
determining that the at least one image has not been eliminated by non-image data within the input file; and
determining that the at least image is described in the input file by data in a supported file format.

6. The method of claim 1, additionally comprising, after receiving the computer readable input file and before extracting the image data, steps of:
displaying the at least one image on a display screen; and
receiving a user selection from a selection device indicating that the at least one image is to be enhanced.

7. A bridge server computer system comprising data and instruction storage and a processor programmed to:
receive a computer readable input file including data describing at least one image;
extract image data describing the at least one image from the computer readable input file;
generate and store a replacement package data structure including information identifying and locating the at least one image;
generate extracted image data describing the at least one image to be manipulated to enhance the image;
generate a printable output file by placing at least one image generated from a corrected version of the image data according to the replacement data structure; and
transfer the printable output file to a printer for printing.

8. The bridge server computer system of claim 7, wherein the processor is additionally programmed to:
transmit the extracted image data to an image enhancement computer system; and
receive a corrected version of the extracted image data from the image enhancement computer system.

9. The bridge server computer system of claim 7, wherein the processor, operating in a multitasking environment, is additionally programmed to manipulate the image data to enhance the at least one image.

10. The bridge server computer system of claim 7, wherein the processor is programmed to:
extract the image data from a computer readable input file in a PDF file format: and generate the printable output file in a PDF file format.

11. The bridge server computer system of claim 7, wherein the processor is additionally programmed to:
determine that the at least one image has not been eliminated by non-image data within the input file; and
determine that the at least image is described in the input file by data in a supported file format.

12. The bridge server computer system of claim 7, additionally including a display device and a selection device for providing user inputs, wherein
the processor is additionally programmed to display at least one image derived from the image data included in the computer readable input file, and to receive a selection input from the selection device, and
the image data describing the at least one image is extracted from the computer readable input file in response to determining that the image has been selected with the selection device.

13. A computer readable medium having computer-executable instructions for performing a method comprising:
receiving a computer readable input file including data describing at least one image;
extracting image data describing the at least one image from the computer readable input file;
generating and storing a replacement package data structure including information identifying and locating the at least one image;
generating extracted image data describing the at least one image to be manipulated to enhance the image;
generating a printable output file by placing at least one image generated from a corrected version of the image data according to the replacement data structure; and
transferring the printable output file to a printer for printing.

14. The computer readable medium of claim 13, wherein the method additionally comprises;
transmitting the extracted image data to an image enhancement computer system; and
receiving a corrected version of the extracted image data from the image enhancement computer system.

15. The computer readable medium of claim 13, additionally having computer readable instructions for performing a method in a multitasking environment, comprising manipulating the image data to enhance the at least one image.

16. The computer readable medium of claim 13, wherein the method includes:
extracting the image data from a computer readable input file in a PDF file format: and
generating the printable output file in a PDF file format.

17. The computer readable medium of claim 13, wherein the method additionally comprises, after receiving the computer readable input file and before extracting the image data, steps of:
determining that the at least one image has not been eliminated by non-image data within the input file; and
determining that the at least image is described in the input file by data in a supported file format.

18. The computer readable medium of claim 13, wherein
the method additionally includes displaying an image derived from the image data included in the computer readable input file and receiving a selection input from a selection device, and
the image data describing the image is extracted from the computer readable input file in response to determining that the image has been selected with the selection device.

19. A computer data signal embodied in a carrier wave having computer-executable instructions for performing a method comprising:
receiving a computer readable input file including data describing at least one image;
extracting image data describing the at least one image from the computer readable input file;
generating and storing a replacement package data structure including information identifying and locating the at least one image;
generating extracted image data describing the at least one image to be manipulated to enhance the image;
generating a printable output file by placing at least one image generated from a corrected version of the image data according to the replacement data structure; and
transferring the printable output file to a printer for printing.

20. The computer data signal of claim 19, wherein the method additionally comprises;
transmitting the extracted image data to an image enhancement computer system; and
receiving a corrected version of the extracted image data from the image enhancement computer system.

21. The computer data signal of claim 19, additionally having computer readable instructions for performing a method in a multitasking environment, comprising manipulating the image data to enhance the at least one image.

22. The computer data signal of claim 19, wherein the method includes:
extracting the image data from a computer readable input file in a PDF file format: and generating the printable output file in a PDF file format.

23. The computer data signal of claim 19, wherein the method additionally comprises, after receiving the computer readable input file and before extracting the image data, steps of:
determining that the at least one image has not been eliminated by non-image data within the input file; and
determining that the at least image is described in the input file by data in a supported file format.

24. The computer data signal of claim 19, wherein
the method additionally includes displaying an image derived from the image data included in the computer readable input file and receiving a selection input from a selection device, and
the image data describing the image is extracted from the computer readable input file in response to determining that the image has been selected with the selection device.
